(19) United States
(12) Patent Application Publication
(10) Pub. No.: US 2008/0190880 A1
(43) Pub. Date: Aug. 14, 2008

(54) Wadless Closure

(75) Inventors: Michael William Needham, Podington (GB); Graham Martin Gossedge, Didcot (GB)

Correspondence Address: NIXON PEABODY, LLP, 401 9TH STREET, NW, SUITE 900, WASHINGTON, DC, 20004-2128, US

(73) Assignee: OBRIST CLOSURES SWITZERLAND GMBH, Reinach (CH)

(21) Appl. No.: 11/629,979

(22) PCT Filed: Jun. 10, 2005
(86) PCT No.: PCT/EP05/52701

§ 371 Date: Apr. 5, 2007

(30) Foreign Application Priority Data
Jun. 23, 2004 (EP) 04253733.2

(51) Int. Cl. B65D 51/20; B65D 53/04; B67B 5/00

(52) U.S. Cl. 215/232; 428/200; 215/341; 215/344; 53/477; 53/485

(57) ABSTRACT

A closure (100,200) for a container (210), the closure (100,200) comprising a wadless membrane (20,220) and a shell (30), wherein the membrane (20,220) is adapted to be heat sealed to a rim (217) of a container to provide a gas-tight barrier, wherein the shell (30) has a downwardly extending resilient sealing element (40,240) for providing an even sealing pressure to the membrane (20,220) during heat sealing and for providing a gas-tight re-seal once the membrane (20,220) has been broken or removed.

The present invention relates to a closure, comprising a shell and a membrane, for a container and a method of sealing a container with such a closure.

Closures are known which comprise a membrane to be sealed to the rim of a container, overlain by a shell which protects the membrane's relatively delicate nature. Correspondingly, containers are known in association with these closures wherein a membrane has been sealed to the rim and is protected by a shell. Once the membrane is removed, the shell is then used to re-seal the container, since the shell is manufactured from a relatively good gas-tight material. This type of closure is often used for products such as coffee granules where it is necessary to have a gas-tight barrier well sealed over the container's opening to maintain shelf-life of the product. This barrier is provided by a membrane such as an aluminium foil. Once purchased, the shell is firstly removed. The foil is then also removed to allow access to the product. Since products are often not consumed all at once it is preferable that the container be closed by as good a gas-tight barrier and with as good a seal between barrier and container as possible. This is typically achieved by re-fitting the shell to the container. The shell alone is accepted as being a poorer gas-tight barrier than a well sealed membrane.

One well known closure comprises a membrane and a wad which together rest inside a shell prior to fitting to the container. The membrane and wad have an adhesive, positioned between them to retain the two together. A further layer of adhesive is positioned on the side of the membrane closest to the container, when fitted. When the shell is positioned on the container it provides a closing force which applies pressure to the further layer of adhesive and to the membrane. The layer of adhesive then adheres the membrane to the rim of the container. This may be achieved by heat activation of the adhesive layer by means of induction heating. Alternatively the adhesive may be of the so-called “hot melt glue” variety which does not require further heat for activation but rather, simply adheres the membrane to the rim of the container by means of the pressure applied by the shell.

If induction heating is employed the heating may also be employed to weaken the layer of adhesive lying between the membrane and wad. This has the effect that when the shell is removed the wad remains within the shell and the membrane remains sealed and affixed to the rim of the container.

The purpose of the wad is two-fold. Firstly, it provides a cushion-effect so that an even pressure is applied from the shell to the membrane. This has the advantage that if containers are used which have inherently uneven rim surfaces, the membrane is still efficiently adhered to the rim to ensure effective sealing. Secondly, once the membrane has been removed by the user, the wad provides re-sealing qualities against the rim of the container. This is achieved by the resilient nature of the wad. The above described closure is taught in U.S. Pat. No. 6,277,478 --.

A problem inherent with this type of closure is that it is relatively expensive in that a wad and a membrane are provided.

EP 1211180 A --. discloses a closure which has only a membrane and no wad. To provide a sufficient force onto the membrane to seal it to the container's rim, by means of heat induction for instance, a rib is provided on the underside of the shell. This rib is present along and above the rim of the container so that the membrane is squeezed between the two during the sealing of the membrane to the rim. However, the rib is not resilient and does not provide an even force to cater for uneven rims as maybe typically found with glass containers. Accordingly, the membrane is not always perfectly sealed to the rim of the container.

Further, in some instances there is a need for the closure to be oriented on the container in a particular manner. For example, if the closure and associated container are not circular in plan. In such a situation if the closure and container are held together by screw threads then there is a possibility, due to manufacturing tolerances in the physical size and relationship of the container and closure, that the rib will not be able to provide sufficient pressure, if any, to press the membrane onto the rim of the container during induction heating. Such a situation does not typically arise where there is no orientational requirement between the closure and container since the problem may be overcome by further twisting of the closure onto the container (so-called “torquing up”).

Another problem with the known rib-type closures is that since this rib is not resilient it does not provide a re-seal quality sufficient to provide a gas-tight seal to keep the product within the container fresh for a relatively long time, such as weeks or even months.

Accordingly, it would be desirable to have a closure which has only a removable membrane for providing a gas-tight barrier on manufacture, but which also has a shell with good re-sealing qualities so that after the membrane has been removed by the user, the re-seal quality is sufficient to maintain the product within the container fresh for a relatively long time. Further, it would be desirable to have a closure which provides an even pressure to a membrane so that it may be sealed effectively to the rim of an associated container.

In one aspect the present invention provides a closure for a container, the closure comprising a wadless membrane and a shell, wherein the membrane is adapted to be heat sealed to a rim of a container to provide a gas-tight barrier, wherein the shell has a downwardly extending resilient sealing element for providing an even sealing pressure to the membrane during heat sealing and for providing a gas-tight re-seal once the membrane has been broken or removed.

In another aspect the present invention provides a method of sealing a container with a closure comprising the steps of moulding a shell, thing the shell to the container wherein a wadless barrier membrane is located between the shell and the container, and adhering the membrane to a rim of the container by heat sealing, wherein the shell comprises a resilient sealing element for providing an even sealing pressure to the membrane during heat sealing and for providing a gas-tight re-seal once the membrane has been broken or removed.

Further embodiments and features of the invention are disclosed in the dependent claims attached hereto.

The present invention and its advantages will be better understood by referring, by way of example, to the following detailed description and the attached Figures, in which:

FIG. 1 shows a cross-section of a closure according to one embodiment of the invention,

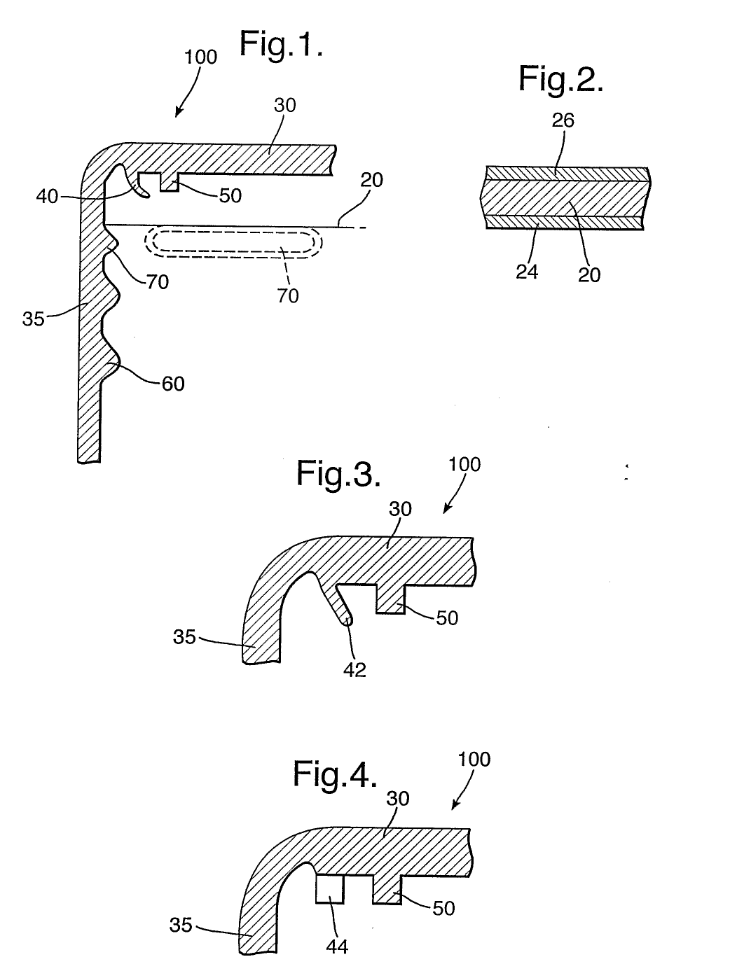

FIG. 2 shows a cross-section of a membrane according to one embodiment of the invention,

FIG. 3 shows an enlarged view of a section of a closure showing one embodiment of a sealing element,

FIG. 4 shows an enlarged view of a section of a closure showing another embodiment of a sealing element, and

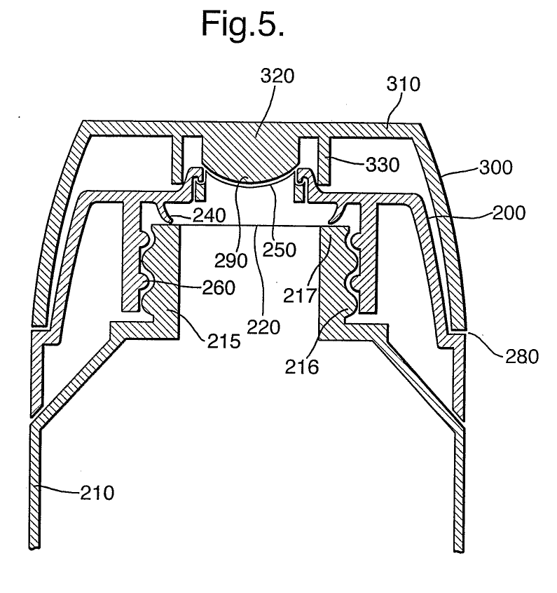

FIG. 5 shows a cross-sectional side view of yet another embodiment of a closure according to the present invention.

In FIG. 1, a closure 100 comprises a shell 30 which has a top plate and a downwardly extending skirt 35. In this specification, orientational words such as “downwardly” are used with regard to the drawings and are not meant to be limiting.

This skirt 35 has screw threads 60 positioned on the inside and projecting radially inward. These screw threads 60 interact with screw threads (not shown) positioned on the outside of a container's neck area so as to enable the closure 100 to be screwed onto the container.

A membrane 20 is also shown. Before being sealed to the container the membrane 20 is placed inside the closure 100 so that it initially rests on projections 70. These projections 70 exist in an annulus around the inside of the skirt 35. They may be either in the form of a continuous annulus or a discontinuous annulus. Alternatively, no projections 70 may be provided and the membrane 20 may just rest on the threads 60.

Membrane 20 lies on top of the container and provides a gas-tight barrier when adhered to the rim of the container. This is not only due to the seal between the rim and the membrane (20) but also due to the oxygen barrier qualities of the membrane (20).

From the underside of the shell 30 a downwardly extending claw-type sealing element 40 is present in a annulus around the inside of the perimeter of the shell 30. Such a claw-type sealing element is known from GB-A-2,222,821.

A stop 50 downwardly extending from the underside of the shell may also be present. This stop 50 is also annular and lies around the perimeter of the shell but radially inward from the claw-type sealing element 40.

The claw-type sealing element 40 is a rib which, in cross-section, tapers towards the end distal from the shell. It has a curved nature so that it gently curves radially inward. However, the sealing element 40 may also curve radially outward.

During manufacture, the membrane 20 is fitted inside the shell 30 and held either by projections 70 or threads 60. The shell 30 is then fitted to the container so that the threads 60 interact to hold the two together. The shell 30 may be fitted by either being pushed over the container's mouth or by rotation. If fitted by being pushed over the container's mouth, the shell will flex slightly to allow the threads 60 on the inside of the skirt to jump or pass over the threads 70 on the outside wall of the container before resuming its initial shape to ensure that the two sets of threads engage properly.

Once in place, the resilient sealing element 40 provides a force to push the membrane onto the rim of the container. The force is evenly distributed by the resilient nature of the sealing element 40 which ensures that even when containers with uneven rims are used the membrane may be efficiently sealed to the container. Typical materials used to fabricate containers which may have uneven rim surfaces are glass and metal. In the latter case, metal containers which have welded seams often have a so-called “weld-step” on the rim which can exacerbate the unevenness.

A cross-section of one type of membrane 20 is shown in FIG. 2. The membrane 20 has a layer of sealing adhesive 24 shown on its lower surface. However, this layer of adhesive 24 may be provided directly on to the rim of the container, rather than as a layer with the pre-formed membrane 20. If non-heat-activated adhesive 24 is employed the pressure provided by the sealing element 40 will seal the membrane 20 to the rim of the container. However, if heat-activated adhesive 24 is employed the combined container and closure 100 are passed through apparatus which provides heat to the adhesive layer 24. One typical method is by induction-heating of the membrane 20, which then passes heat to the adhesive layer 24 by means of conduction. In this case the membrane 20 has to have at least a partial metallic composition. However, other forms of heating the adhesive 24 are known such as direct conduction heating. In addition to heat being provided, pressure is provided by the resilient sealing element so that the combination of the heat and pressure seals the membrane 20 to the rim of the container.

The heating of the heat-activated adhesive layer 24 activates its adhesive qualities so that the membrane 20 is adhered to the rim of the container, thus providing an air-tight, integral and hermetic barrier. However, the adhesive may be chosen so that the membrane may be easily peeled off from the rim of the container.

To aid the peeling off of the membrane a tab (not shown) may be positioned at its edge. In this case the tab may either be downwardly depending from the edge of the membrane so that it is sandwiched between the two sets of threads 60, or may be bent back on itself so that it lies on the top of the membrane. Alternatively, the tab may be positioned on top and away from the edge of the membrane 20. Another possibility is that no tab exists but rather the membrane is sized so that it is slightly larger than the outer rim of the container to provide an edge which can be gripped by the user to aid peeling off of the membrane.

The membrane 20 may also have a layer 26 on its upper surface. This layer may comprise any combination of print or lacquer and may also consist of a protective layer formed from a polymer. This layer may also be embossed.

It has been found that, contrary to expectation, the sealing element 40 is not damaged by the heating effect by, for instance, permanent deformation and therefore does not lose its resilience.

Once the user removes the shell 30 and the membrane 20, in order to access the product within the container, the shell 30 is ideally re-fitted to reduce degradation of the product by contact with the atmosphere. This is achieved since the shell 30 may be manufactured from a gas-tight barrier material and it is re-sealed to the rim of the container by screwing it onto the container. The re-seal effect is provided by the sealing element 40 interacting with the top of the rim of the container. Since the sealing element 40 is resilient it applies even pressure even onto an uneven surface such as may occur with glass or metal containers.

Further, it should be understood that the well-sealed initial membrane provides a degree of gas-tightness which is required to keep a product, on the shelf of a shop or in a warehouse, fresh for many months. Conversely, the degree of gas-tightness required after the product has been bought and opened is less since typically the product is consumed within a few weeks.

Accordingly, it is accepted that the gas-tight barrier properties of a re-fitted shell are poorer than the initial well-sealed membrane. However, it has been shown that a shell with the above described resilient element substantially improves the gas-tightness compared to the prior art.

To prevent over-tightening of the shell 30 with the container, a stop 50 may be provided as described above with reference to FIG. 1. The rim of the container will meet the underside of the stop 50 and prevent the shell 30 from moving closer to the rim of the container.

It may be arranged that the resilient sealing element 40 is pinched between the stop and the rim of the container to provide a seal.

In FIGS. 3 and 4 two further embodiments of resilient sealing elements are shown. The element 42 FIG. 3 takes the form of a “finger” shape. Although shown as approximately having the same cross-section along its length it could be frusto-conical in shape.

FIG. 4 shows an embodiment whereby a block of resilient material 44 different from the material of the rest of the closure, is formed with the material of the rest of the closure using such known methods as bi-injection moulding to produce a one-piece closure. An example of such resilient material is TPE (thermoplastic elastomer).

Another embodiment of the present invention is shown in FIG. 5 and relates to closures which have to be oriented onto an associated container neck in a particular way so that the closure and container lie in a specific orientation relative to one another. Such closures and containers are known in which the cross-sectional shape is oval. However, other non-circular shapes are also contemplated. For example, shampoo or shower-gel like containers are often produced wherein the closure fits onto the shoulder of the container such that there is an unbroken surface between the two: Of course, there could be reasons why container/closure combinations which are circularly shaped in plan may be required to have orientational relationships. Further, such container/closure combinations can of course also be used for other products such as food products.

A container 210 is shown with a closure 200 fitted. The container has a neck portion 215 which includes threads 216 on its outer radial surface. These threads 216 are for interaction with the threads 260 on the closure 200 so as to hold the two parts 200,210 together. Although not shown, it is contemplated that the closure is not circular in plan but rather is oval. Accordingly, the closure 200 can only sit correctly on the container in two positions (each 180 degrees away from the other, about an axis running through the container 210 and closure 200 through the centre of the discharge orifice 290) to produce the overall desired shape.

To ensure that the container 210 and closure 200 will fit together correctly and to seal the container with the closure the threads 216, 260 are carefully designed. However, due to the nature of the material used in the manufacture of the container and closure and the tolerances which are inherent in such manufacturing processes it is not possible to guarantee a gas-tight seal between the container 210 and closure 200.

By use of the above described invention this problem is overcome and it is possible to provide this gas-tight seal after filling.

This is achieved by having a downwardly depending resilient sealing element 240 which provides an even sealing pressure to a membrane 220 which is positioned across the top and over the orifice 290 of the container neck 215. This is achieved because the resilient sealing element 240 will compensate for the tolerances of the closure/container combination. In other words, the resilient sealing element 240 will compensate for any possible gap between the underside of the closure 200 and the rim 217 of the container.

The membrane 220 is positioned and then sealed across the top of the container mouth by such methods as described above, for example by heat sealing.

Once the membrane 220 is removed by the consumer, prior to the first discharge of product from the container, the resilient sealing element 240 will also provide a gas-tight re-seal, as described above, by pressing against the rim 217 of the container's mouth. Since the sealing element 240 is resilient it will compensate for the removal of the membrane 220 even though this will slightly increase the gap between the underside of the closure 200 and the top of the rim 217 of the container.

To be able to discharge product from the container the closure may simply be removed by unscrewing from the container. Alternatively the closure could have an orifice 290 in its upper surface. This orifice 290 would then need to be sealed in a gas-tight manner to maintain the life of the product within the container 210. This may be achieved in a number of different ways not all of which are shown in FIG. 5.

For instance, another secondary closure device 300 could be associated with the primary closure 200. This secondary closure could be in the form of a cover 310. This cover 310 could be hinged to the primary closure 200, at, for example, the point marked 280 in FIG. 5. Alternatively, the secondary closure 300 could have a sliding relationship with the closure 200, or simply be completely detachable.

On the underside of the secondary closure 300 a simple plug could be formed which would have an interference fit with the orifice 290 to seal it thereby. Alternatively, an annulus 330 could be formed on the underside of the closure 300 which would have an interference fit with the outside of the orifice 290. Of course both alternatives could be also be employed at the same time.

In one embodiment the orifice 290 may have a self-closing valve 250, such valves being well known in the art, provided These valves typically do not provide a gas-tight re-seal without some form of mechanical interaction from a lid. Accordingly, in the embodiment with such a valve 250, as shown in FIG. 5, a projection 320 is formed on the underside of the cover 310. Further an annulus 330, as described above, is also formed on the underside of the cover 310. The projection 320 presses against, or at least is very close to, the valve 250 when the secondary closure 300 is in the closed position in relation to closure 200. This prevents the valve 250 from opening. Further, and again when the secondary closure 300 is in the closed position in relation to the closure 200, the annulus 330 has an interference fit around the outside of the orifice 290. These two mechanical means provide a gas-tight seal. Accordingly, even when the membrane 220 has been removed from the container 210 the contents of the container 210 are maintained in a gas-tight manner. This is because of the resilient sealing element 240 together with the means described above provided on the secondary closure 300.

Although the embodiment described above in relation to FIG. 5 is shown with the closure at the top of the container it should be understood that in fact the closure could be situated at the bottom of the container.

With regard to the membrane 20, 220 in any of the above described embodiments, it is possible to use aluminium foil. Such foil typically has a thickness of between 9 and 200 μm. Other metals and materials are also possible.

Although it has been described how the membrane 20, 220 is fitted inside the shell 30 prior to fitting the shell 30 to the container, it is also possible that instead the membrane is positioned over the rim of the container prior to the shell being fitted. In this case the membrane 20, 220 may be sealed to the rim of the container by external pressure and/or heat supplied by the manufacturing apparatus.

Also, the closure 100, 200 has been described as having screw threads 60, 260 which interact with corresponding screw threads on the container's neck. However, screw threads are not essential since the closure 100, 200 could be snap fitted to the container by means of beads well known in the art.

Further, the membrane 20, 220 may be designed so that rather than being removable by peeling it is merely broken through so that the membrane may still be in position in the vicinity of, and on top of, the rim of the container.

Further still, the type of container with which such a closure 100, 200 may be used is not limited to glass, but may be of other typically used materials such as PET, polypropylene or metal such as aluminium or tin-plated steel.

Finally, the closure could be of the flip-top type.

1.-13. (canceled)

14. A heat sealable wadless container closure, the closure comprising a wadless membrane and a shell with a top plate and a depending skirt, wherein the membrane is adapted to be heat sealed to a rim of a container to provide a gas-tight barrier, and the shell has a single resilient sealing element depending from the top plate, the sealing element having an elongate body with a base end adjacent the top plate and a free end radially and axially spaced from the base end, the sealing element body is arranged so that, in use, it contacts only the top of the rim of the container and is spaced from the top plate of the shell at all times so as to provide even pressure to the membrane during heat sealing and to provide a gas-tight re-seal on the top of the rim of the container once the membrane has been broken or removed.

15. The closure according to claim 14, including a stop being arranged to contact, in use, the top of the rim of the container to limit the axial movement of the closure relative to the container.

16. The closure according to claim 14, wherein the closure is non-circular.

17. The closure according to claim 14, wherein shell skirt includes a projection for receiving the membrane.

18. The closure according to claim 14, wherein the membrane ranges from 9 μm to 200 μm in thickness.

19. The closure according to claim 14, wherein the membrane includes a tab.

20. The closure according to claim 14, wherein the sealing element is a claw-type sealing element.

21. The closure according to claim 14 in combination with a container.

22. A method of sealing a container with a heat sealable wadless closure, comprising the steps of:
(a) forming the shell of claim 14;
(b) fixing the shell to the container wherein a wadless barrier is located between the shell and the container; and
(c) adhering the membrane to the rim of the container by heat sealing.

23. The method of sealing the container of claim 22, wherein the membrane is retained in the shell prior to being sealed to the rim of the container.
